(19) United States
(12) Patent Application Publication
(10) Pub. No.: US 2016/0349379 A1
(43) Pub. Date: Dec. 1, 2016

(54) INERTIAL NAVIGATION UNIT ENHACED WITH ATOMIC CLOCK

(71) Applicants: Alberto Daniel Lacaze, Potomac, MD (US); Karl Nicholas Murphy, Rockville, MD (US); Raymond Paul Wilhelm, III, Gaithersburg, MD (US)

(72) Inventors: Alberto Daniel Lacaze, Potomac, MD (US); Karl Nicholas Murphy, Rockville, MD (US); Raymond Paul Wilhelm, III, Gaithersburg, MD (US)

(21) Appl. No.: 15/168,460

(22) Filed: May 31, 2016

Related U.S. Application Data
(60) Provisional application No. 62/167,723, filed on May 28, 2015.

(51) Int. Cl. G01S 19/47; G01S 5/02; G01S 19/26; G01S 19/21; G01S 19/41

(52) U.S. Cl. CPC G01S 19/47; G01S 19/215; G01S 19/41; G01S 19/26; G01S 5/0263

(57) ABSTRACT

An atomic clock is used in conjunction with the GNSS receiver and the inertial sensors, creating a more capable inertial navigation system (INS). The system is composed of a GNSS receiver, an accurate clock, and a mechanism for measuring relative pose changes. The system being presented utilizes an inertial measurement unit (IMU) to provide the relative pose changes, but other mechanisms can be used—like visual and ladar odometry. The GNSS receiver measures the pseudo-ranges to the GNSS satellites in the field of view. These measurements are “time tagged” with the accuracy of the atomic clock. The relative motion between the pseudo-ranges is measured using the IMU. Finally, the lock is achieved by filtering these measurements. The filtering mechanism can vary, from the traditional Kalman Filters to other mechanisms that attempt to minimize the mean square error.

### CROSS REFERENCE TO RELATED APPLICATIONS

This Application claims priority from U.S. patent application Ser. No. 62/167,723, entitled “INERTIAL NAVIGATION UNIT ENHACED WITH ATOMIC CLOCK”, filed on May 28, 2015. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to inertial navigational units. More specifically, the present invention relates to inertial navigation systems (INS) and units that utilize a combination of inertial sensors (accelerometers and gyroscopes) and Global Navigation Satellite System (GNSS) to find relative and absolute location.

### BACKGROUND OF THE INVENTION

Inertial navigation units utilize a combination of inertial sensors (accelerometers and gyroscopes) and Global Navigation Satellite System (GNSS) to find relative and absolute location. GNSS includes a global positioning system (GPS), global navigation satellite system (GLONASS), GALILEO or other state and private satellites. There are a variety of published algorithms that describe, in detail, how to filter the measurements provided by the inertial sensors and the GNSS receiver. The inertial sensors provide relative localization, while GNSS provides an absolute frame of reference that helps the unit localize with respect to the world. The GNSS receiver senses sequences of known signals that are emitted by each satellite. Since these sequences travel close to the speed of light, the unit is capable of resolving its location by comparing the times between the received signals from the different satellites, and knowing the location of each satellite. A minimum of four pseudo-ranges to different satellites are necessary to fully solve (“get a lock”) for the localization (x,y,z) and time unknowns.

While the satellites have accurate atomic clocks, most modern GNSS receivers use less accurate quartz clock. Quartz clocks—though accurate for most applications—have significant drift when used to measure the minute times required to localize by these signals (travelling close to the speed of light). In other words, the four pseudo-range measurements need to be taken in very close time proximity by a GNSS receiver, before they can be used to solve for the “lock”. When compared to the speed of light, quartz clocks can drift as much as 150 m/s, and therefore, waiting one second between these four measurements can add 150 m to the error of the location solution.

Unfortunately, this means that in order to “get a lock,” conventional GNSS systems need to have full view of at least four GNSS satellites at a given moment of time. This is relatively easy to do in open areas but it is significantly harder in big cities, where occlusions can mask significant areas of the sky.

### DEFINITIONS

An atomic clock is a clock device that uses an electronic transition frequency in the microwave, optical, or ultraviolet region of the electromagnetic spectrum of atoms as a frequency standard for its timekeeping element. Atomic clocks are the most accurate time and frequency standards known, and are used as primary standards for international time distribution services, to control the wave frequency of television broadcasts, and in global navigation satellite systems such as GPS.

An inertial navigation system (INS) is a navigation aid that uses a computer, motion sensors (accelerometers) and rotation sensors (gyroscopes) to continuously calculate via dead reckoning the position, orientation, and velocity (direction and speed of movement) of a moving object without the need for external references. It can also use other motion sensors such as wheel odometers. INS is used on vehicles such as ships, aircraft, submarines, guided missiles, and spacecraft. Other terms used to refer to inertial navigation systems or closely related devices include inertial guidance system, inertial reference platform, inertial instrument, inertial measurement units (IMU) and many other variations.

GALILEO is the global navigation satellite system (GNSS) that is currently being created by the European Union (EU) and European Space Agency (ESA), headquartered in Prague in the Czech Republic, with two ground operations centers, Oberpfaffenhofen near Munich in Germany and Fucino in Italy.

LADAR (also known as LIDAR) is an optical remote sensing technology that can measure the distance to, or other properties of a target by illuminating the target with light, often using pulses from a laser. LIDAR technology has application in geomatics, archaeology, geography, geology, geomorphology, seismology, forestry, remote sensing and atmospheric physics, as well as in airborne laser swath mapping (ALSM), laser altimetry and LIDAR contour mapping. The acronym LADAR (Laser Detection and Ranging) is often used in military contexts. The term “laser radar” is sometimes used, even though LIDAR does not employ microwaves or radio waves and therefore is not radar in the strict sense of the word.

In computing, a graphical user interface (GUI, commonly pronounced gooey) is a type of user interface that allows users to interact with electronic devices using images rather than text commands. GUIs can be used in computers, hand-held devices such as MP3 players, portable media players or gaming devices, household appliances and office equipment. A GUI represents the information and actions available to a user through graphical icons and visual indicators such as secondary notation, as opposed to text-based interfaces, typed command labels or text navigation. The actions are usually performed through direct manipulation of the graphical elements.

The terms location and place in geography are used to identify a point or an area on the Earth's surface or elsewhere. The term location generally implies a higher degree of certainty than place, which often indicates an entity with an ambiguous boundary, relying more on human/social attributes of place identity and sense of place than on geometry.

An “absolute location” is designated using a standard geographic coordinate system such as a specific pairing of latitude and longitude, or a Cartesian coordinate grid—for example, a Spherical coordinate system or an ellipsoid-based system such as the World Geodetic System—or similar methods. Absolute location, however, is a term with little real meaning, since any location must be expressed relative to something else. For example, longitude is the number of degrees east or west of the Prime Meridian, a line arbitrarily chosen to pass through Greenwich, London. Similarly, latitude is the number of degrees north or south of the Equator. Because latitude and longitude are expressed relative to these lines, a position expressed in latitude and longitude is actually a relative location.

A “relative location” is described as a displacement from another site where the site is typically not located on a standard geographic coordinate system. For example, the site could be located where the system was turned on.

A satellite navigation or satnav system is a system of satellites that provide autonomous geo-spatial positioning with global coverage. It allows small electronic receivers to determine their location (longitude, latitude, and altitude) to high precision (sub meters) using time signals transmitted along a line of sight by radio from satellites. The signals also allow the electronic receivers to calculate the current local time to high precision, which allows time synchronization. A satellite navigation system with global coverage may be termed a global navigation satellite system (GNSS).

### SUMMARY OF THE INVENTION

Atomic clocks are very accurate clocks that provide very low drift rates with orders of magnitude more accurate than quartz (or other clocks technologies). In the present invention, an atomic clock is used in conjunction with the GNSS receiver and the inertial sensors, creating a more capable Navigation System. As opposed to current navigation units—which require line of sight to four satellites simultaneously—the present invention can produce a lock by acquiring individual pseudo-ranges at different times, and solving for the lock by utilizing the accurate time tags provided by the atomic clock. The present invention becomes important in urban scenarios, where different parts of the sky are blocked at different times.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1A illustrates a GNSS with a quartz clock requires 4 satellites to get a lock.

FIG. 1B illustrates four satellites, at one time, are hard to achieve in an urban scenario.

FIG. 1C illustrates the proposed atomic clock enabled system can get a fix by using separate measurements to different satellites performed at different times.

FIG. 2 is a flow chart illustrating the components and connectivity of the components of the present invention.

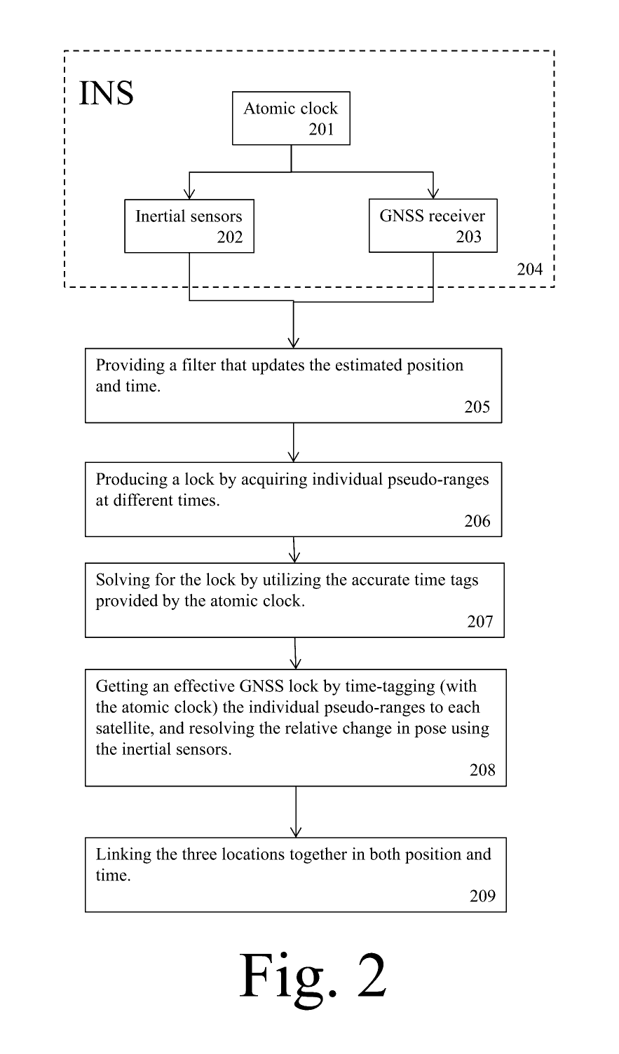

FIG. 3 is a flow chart illustrating the process and method of the system of the present invention.

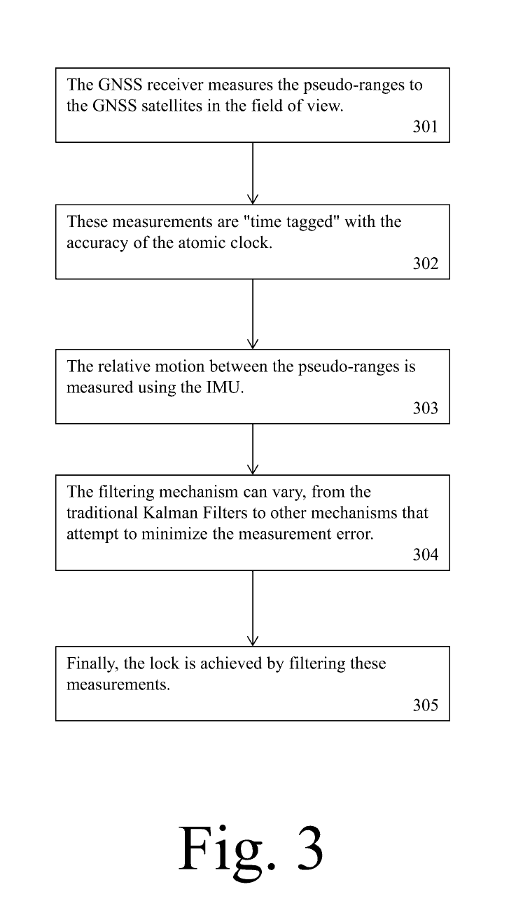

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Atomic clocks 201 are very accurate clocks that provide very low drift rates with orders of magnitude more accurate than quartz (or other clocks technologies).

In the present invention, an atomic clock 201 is used in conjunction with the GNSS receiver 203 and the inertial sensors 202, creating a more capable INS 204. As opposed to current navigation units—which require line of sight to four satellites simultaneously. The present invention can produce a lock by acquiring individual pseudo-ranges at different times 206, and solving for the lock by utilizing the accurate time tags 207 provided by the atomic clock 201.

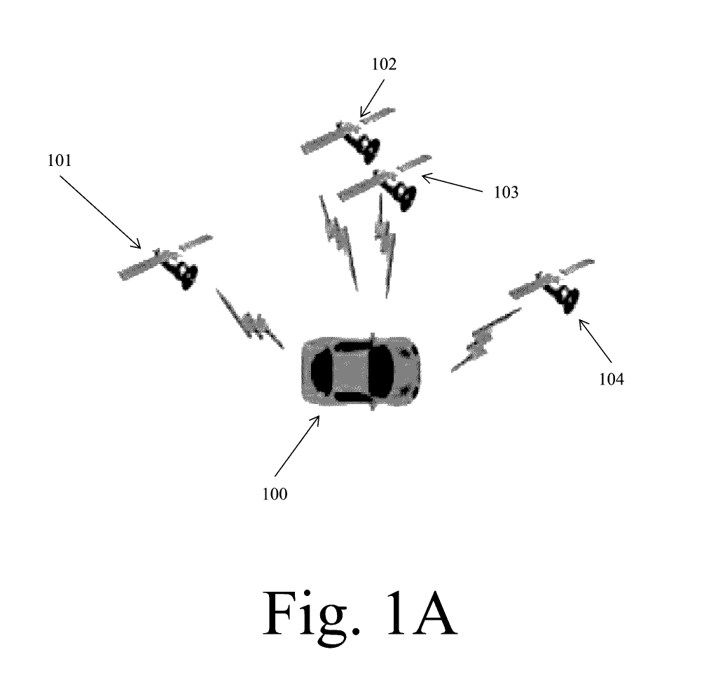

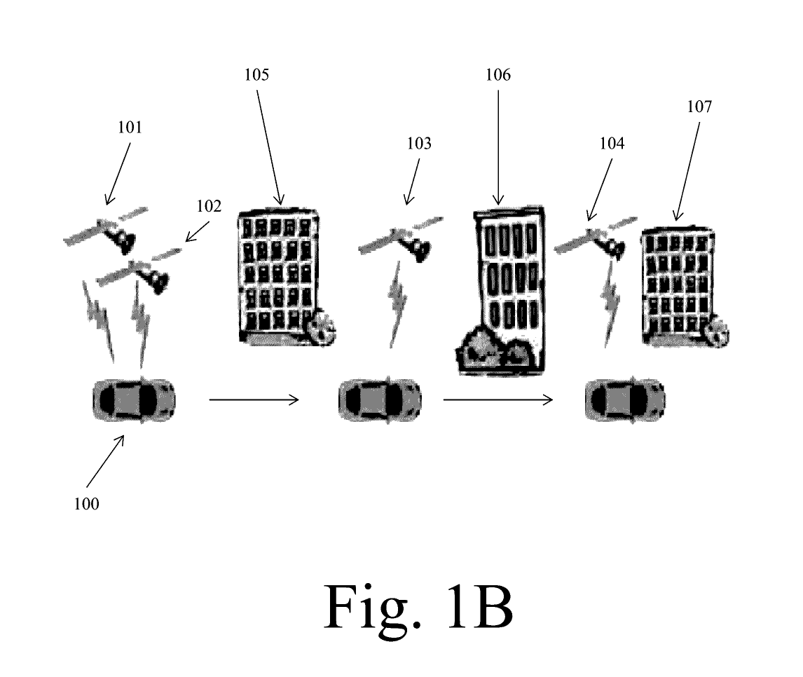

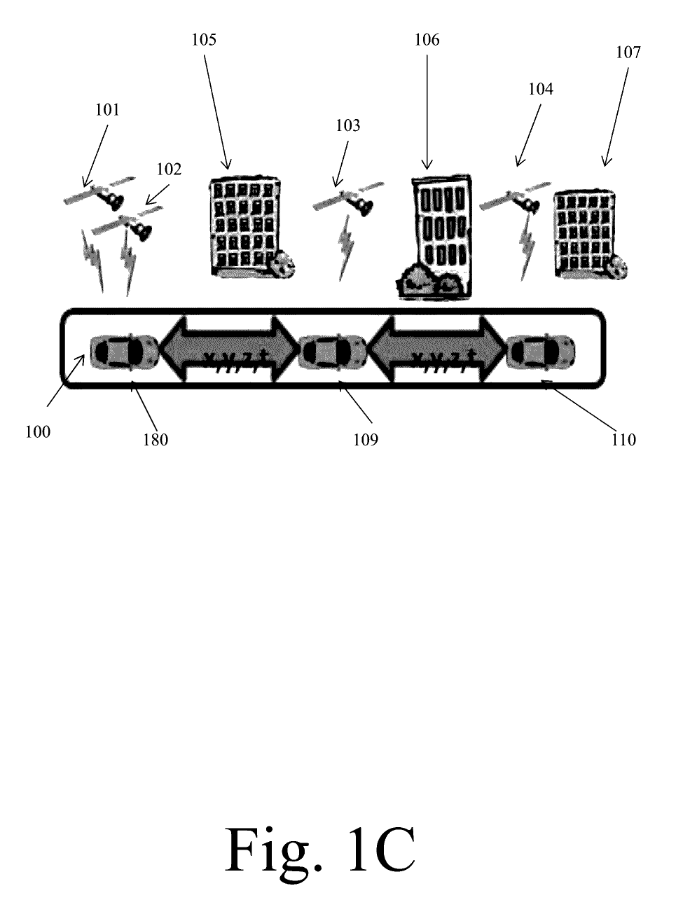

The present invention becomes important in urban scenarios, where different parts of the sky are blocked at different times by obstructions 105, 106, and 107. For example, in FIG. 1A, when the receiver 100 has line of sight to four satellites 101, 102, 103, and 104, it can obtain a GNSS fix, but if the sky is partially blocked, as in FIG. 1B a traditional GNSS receiver is not capable of providing a lock, even though it has been able to get line of sight to four satellites, although at different times and locations as the car moves down a city street and through various obstructions 105, 106, and 107. The quartz clock drifted too much between measurements to be able to provide an accurate lock.

In FIG. 1C, the present invention is capable of getting an effective GNSS lock by time-tagging (with the atomic clock) the individual pseudo-ranges to each satellite 101, 102, 103, and 104, and resolving the relative change in pose using the inertial sensors 208. The three locations 108, 109, and 110 are linked together in both position and time 209.

In addition, the present invention does not need to wait see four satellites to get an update. Instead, the inertial measurements, the atomic clock signal, and any GNSS signal(s) can be feed into a filter that updates the estimated position and time 205.

Advantages of the new invention from a lock standpoint: clear line of sight can be one satellite at a time, as opposed to the current four-at-a-time requirement. Only three satellites are necessary if absolute time is measured at a previous time by the atomic clock. Only three satellites are necessary if elevation is known (barometer or other means). Only two satellites are necessary if elevation and absolute time are known.

Other advantages: Having an atomic clock 201 on the receiver 100 will make it significantly harder to spoof the receiver. The “spoofer” will need to know absolute time and an accurate location of the GNSS unit, in order to create the spoofing signal. Even under those conditions, spoofing becomes significantly more complicated. Having an onboard atomic clock 201 allows for the synchronization of other sensors, like RADAR, from multiple vehicles.

The system is composed of a GNSS receiver, an accurate clock, and a mechanism for measuring relative pose changes. Currently, atomic clocks are the most capable technology that provides the required accuracy; however, it is likely that, in the future, other accurate clock technologies will be implemented. The system being presented utilizes an inertial measurement unit (IMU) to provide the relative pose changes, but other mechanisms can be used—like visual and ladar odometry.

The GNSS receiver measures the pseudo-ranges to the GNSS satellites in the field of view 301. These measurements are “time tagged” with the accuracy of the atomic clock 302. The relative motion between the pseudo-ranges is measured using the IMU 303. Finally, the lock is achieved by filtering these measurements 305. The filtering mechanism can vary, from the traditional Kalman Filters to other mechanisms that attempt to minimize the measurement error 304.

Although, in this write-up, we have treated the GNSS receiver separately from the atomic clock, it is clear that these two systems can be combined.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. The device providing absolute and relative localization, composed of:
a computer system for receiving and time-tagging pseudo-ranges from one or more Global Navigation Satellite Systems (GNSS);
an accurate clock;
a relative localization system that can measure the change in pose between subsequent GNSS measurements; and
a filtering mechanism that can solve to find position.

2. The device of claim 1, comprising
a different filtering mechanism that utilizes the pseudo-ranges and carrier phase measurements to improve on the relative positioning.

3. The device of claim 1, using the clock and possible skews to detect spoofing.

4. The device of claim 1, further comprising of
visual odometry or ladar odometry, to provide relative localization between GNSS measurements.

5. The device of claim 1, further comprising
an external relative of absolute position measurement.

6. The device of claim 5, wherein the external relative of absolute position measurement is taken from a barometer, inclinometer, or compass.

7. The device of claim 1, wherein the GNSS receiver and the clock are implemented as a single device.

8. The device of claim 1, using measurements from another vehicle to calculate the relative position between vehicles using a differential GNSS filtering mechanism.

9. The device of claim 1, wherein
the absolute time in two systems or vehicles is used to provide a GNSS lock.

10. The device of claim 9, wherein
the relative position between the two or more vehicles is measured directly or indirectly using visual or LADAR matching.

11. The device of claim 1, wherein
the onboard clock is adjusted to absolute time using a lock from the satellites.

12. The device of claim 11, wherein the onboard clock is adjusted to absolute time using a lock from the satellites when all satellites are seen at the same time, or when the satellites are seen sequentially.

13. The device of claim 1, further comprising
using two or more satellites on the GNSS from different sources, in combination, to get a fix.

14. The device of claim 1, further comprising the capability of determining an objects orientation.

15. The device of claim 1, wherein the one or more GNSS sources is selected from a Global Positioning System (GPS), GLONASS, and GALILEO.

16. The device of claim 1, wherein the clock is an atomic clock.

17. An inertial navigation system (INS) comprising:
a GNSS receiver;
an atomic clock; and
a mechanism for measuring relative pose changes;
utilizing an inertial measurement unit (IMU) to provide the relative pose changes;
the GNSS receiver measures the pseudo-ranges to the GNSS satellites in the field of view;
these measurements are time tagged with the accuracy of the atomic clock;
the relative motion between the pseudo-ranges is measured using the IMU;
the lock is achieved by filtering these measurements.

18. The device of claim 1, wherein visual and ladar odometry are used to provide the relative pose changes.

19. The device of claim 1, wherein the filtering mechanism is a Kalman Filter to minimize the mean square error.
